(19) United States
(12) Patent Application Publication
(10) Pub. No.: US 2009/0063294 A1
(43) Pub. Date: Mar. 5, 2009

(54) Scoring Feed Data Quality

(76) Inventors: Dennis Hoekstra, San Francisco, CA (US); Tran Bui, Fremont, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/850,483

(22) Filed: Sep. 5, 2007

(51) Int. Cl. G06Q 30/00; G06F 17/30

(52) U.S. Cl. 705/26; 705/1

(57) ABSTRACT

A method and apparatus for scoring a data feed is provided. A feed scoring system takes as an input a data summary file produced by the data feed processing engine. The data file contains field coverage data, attribute extraction data, and mapping data. The data file is processed by the feed scoring system to create a set of scores. The scores are organized and presented in a hierarchical manner.

### FIELD OF THE INVENTION

The present invention relates to generating data feed quality scores for online merchants.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

There are two general ways merchant product data is acquired by shopping sites. A shopping site may utilize a crawler to traverse merchant sites and automatically import data, or merchants may explicitly submit data feeds to the shopping sites. A data feed is a file with a predetermined format that lists products a merchant carries. Merchants typically pay for the privilege to submit data feeds. There are a number of online shopping services that use data feeds to import product data. The online shopping services encompass a range of industries, from apparel shopping to airline tickets and hotels.

Data feeds can come in a number of low level formats such as tab separated, comma separated, or XML. Data feeds can be derived directly from a product database, or data feeds can be created by merchants utilizing any of a number of text editing tools.

To improve the quality and consistency of the data feeds that a shopping site receives, the shopping site may provide a data feed format specification to the merchants. The data feed format specification details the low level data format of a data feed, as well as higher level grouping of data. Attributes of individual products in a data feed are assigned to fields. The data feed specification specifies the format of all possible fields. However any one product typically will not use all of the fields at the same time. For example, a pair of pants for sale will have a different set of fields than a book. For example, a description of a book would not necessarily contain size or gender, while the description of pants typically would. The data feed format specification may also provide some examples of data feeds with proper formatting.

Each product in a data feed should have a field containing a unique identifier, such as a UPC. A data feed may also contain information such as the name of the product, a short description, a price, and the URL where the user is sent once they click on the link displayed along side of the product. Each product in a data feed may also have product-specific data, such as the color of the product, intended gender of the user of the product, the sale price, MSRP as well as other identifiers. The data feed may contain URLs that link to a picture of the product. There may also be fields in the data feed that suggest a potential category. Shopping sites charge merchants different amounts per click depending on the category the product is placed in. In some implementations, merchants may also submit separate data feeds that contain multimedia data that will augment product descriptions.

A merchant can submit a data feed to a comparison shopping engine by uploading the data feed to an ftp account. The data feed then goes through pre-processing. In a pre-processing step, the comparison shopping engine validates the data feed data by performing sanity checks, such as making sure the price field does not contain alpha characters, etc. The comparison shopping engine generates feedback detailing which products have invalid data. Products listed in a data feed containing incorrectly formatted fields are rejected.

The comparison shopping engine maps products that can be uniquely identified into the buyers guide. The buyers guide is a catalog that contains a listing of products, technical specifications and reviews. Each product may be sold by several merchants. The catalog can be created by the shopping web site or obtained from a third party.

Fields such as UPC, brand or part number, or ISBN can be used to create a mapping to an entry in a catalog. If products cannot be readily matched, the data feed information for the products are fed into a categorization engine, where other fields are used to group the products with products already existing in the buyers guide. Individual fields containing data are used to bin or group the same products together and to map to comparison grid pages. Fields are also used to match keyword queries and eventually the fields are used as part of search results.

Products in a data feed also go through a step called attribute extraction. In some cases, merchants will include attributes in the name of the product. For example, the product name “red shoes size 9” includes color and size attribute values. During attribute extraction, the product name string is parsed and “red” and “size 9” are matched to their respective individual fields in the catalog. If the catalog is being built and the corresponding fields do not yet exist, then the appropriate fields are created. The data that is already present in the fields is also placed in separate data structure called a search file.

Once a mapping is created, products can be searched or navigated by category. A shopper may select a set of products to be displayed on a comparison grid page. Comparison grid pages allow shoppers to easily compare and differentiate features of similar products. For each product a comparison shopping engine may also contains a description, user reviews and a list of merchants carrying products. The description need not come from individual merchants, the description that is present in the catalog can be used. The shopper can then easily price match using a comparison grid.

Merchants often do not know what type of data needs to be included for different products, and would greatly benefit from the knowledge. Even if merchants knew which data needs to be provided in the data feed, feedback regarding the quality of the provided data would be useful. It is apparent that the quality of the information in a data feed has a direct impact on where and how the products are displayed on the shopping site. If products are not properly categorized, the products cannot be presented in a comparison grid view to the shoppers visiting the site. Users naturally tend to compare prices and other product attributes before buying anything. If the product data is incomplete, for example the pant color is not given, shoppers using the site would not be able to narrow down their selections based on the pant color attribute. If the description is incomplete, then the products will not show up as relevant in searches. If the fields are not complete, then the shopping site will have trouble characterizing the product. The products may be put in a catchall “general merchandise” category, the “general merchandise” category does not get much traffic from shoppers.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a feed scoring system, according to an embodiment of the present invention;

FIG. 2 is a hierarchy of feed quality scores, according to an embodiment of the present invention; and

FIG. 3 is an example computer system, according to an embodiment of the present invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Techniques are provided for generating a set of feed quality scores. In one embodiment, feed quality scores are derived from information from summary data files generated by a comparison shopping engine. A summary data file contains field coverage data, attribute extraction data, and product mapping data. The summary data file is processed by a feed scoring system to create a set of feed quality scores by looking at the individual data elements in the summary data file, as well as the feed quality scores generated for other merchants. In one embodiment, the scores are organized and presented in a hierarchical manner. Previous approaches did not provide merchants feedback regarding the quality of their submitted data feeds. The set of scores generated by the feed scoring system allows merchants to diagnose potential product placement problems in a comparison shopping engine, as well as compare the feed performance to other merchants.

### System Overview

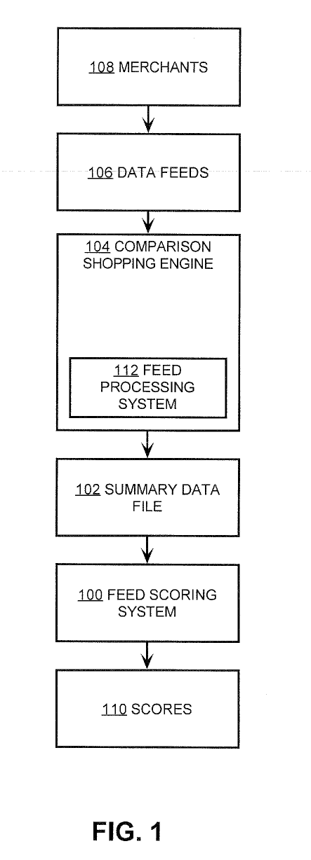

Referring to FIG. 1, it is a block diagram of a feed scoring system according to an embodiment of the invention. The feed scoring system 100 takes as an input a summary data file 102 generated by a comparison shopping engine 104. The comparison shopping engine 104 processes data feeds 106 submitted by merchants 108. During feed processing, various products in the data feed 106 are categorized, attributes are extracted for use in product narrowing functionality, products are matched to comparison grid pages, and products are also added to search files for use in search result displays. Additionally, data used to display product name, description, price, etc., are collected for display on the comparison shopping engine 104. As the feed data is processed, the feed processing system 112 within the comparison shopping engine generates a summary data file 102.

The summary data file contains data generated at various processing steps. The data includes: field coverage data, product categorization data, product attribute data, and comparison grid matching data. The data included in the summary file is used by the feed scoring system to generate a set of scores serve as a quality measure for the various aspects of the data feed.

### Feed Quality Score Hierarchy

According to one embodiment, feed processing system 112 generates fine-granularity feed quality scores, and then generates coarser-granularity feed quality scores based on the fine-granularity feed quality scores. The process of generating the fine-granularity feed quality scores is described in detail hereafter. The relationships between the fine-granularity feed quality scores and the coarse-granularity feed quality scores that are derived therefrom make up a “feed quality score hierarchy”.

In one embodiment, the feed quality scores within a feed quality score hierarchy range in granularity from “overall quality” of the data feed, down to quality of individual data fields in the data feed. In another embodiment of the invention, finer granularity scores may be computed for fields for individual products within a feed. The feed quality score hierarchy shows how individual scores at various levels of granularity are related to each other. The coarsest score is at the top of the feed quality score hierarchy, while to the finest granularity scores are at the bottom of the feed quality score hierarchy. Individual scores at every level of the hierarchy are derived from scores from the level immediately below them in the feed quality score hierarchy.

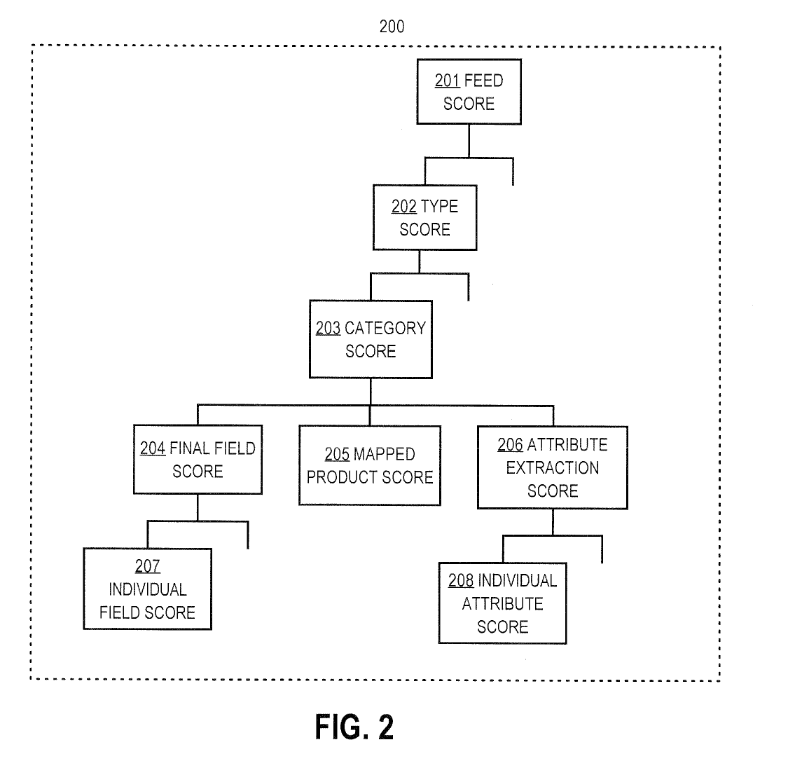

FIG. 2 shows a feed quality score hierarchy 200, according to an embodiment of the invention. Scores at each level of the hierarchy 200 are derived in part from the scores below them in the hierarchy. Feed score 201 is at the top of the hierarchy, and is indicative of the quality of the entire data feed for which the feed quality score hierarchy 200 was generated.

The type score 202 is at a hierarchy level directly below feed score 201. The type score 202 reflects feed quality for a certain product type. Since there can be more than one product type in a data feed, there can be more than one type score 202 in the score hierarchy of a data feed. A product type is a high level grouping of products. For example, type 1 products may be “movies/books/music”, type 2 products may be “apparel”, and type 3 products may be “electronics”.

The category score 203 is directly below the type score 202 in the hierarchy. Product categories subdivide product types. For example, “movies”, “books”, and “music” are categories of type 1 products, while “adult apparel” and “child apparel” are type 2 product categories. For a data feed, for one type score 202 there can be multiple category scores 203.

According to one embodiment, category scores 203 are derived from a “final field” score 204, a “mapped product” score 205, and an “attribute extraction” score 206. Final field score 204 provides a metric on how many fields in a single category in the input feed contained values. Mapped product score 205 indicates a percentage of products within a given category in the input feed which could be displayed in a comparison grid. The attribute extraction score 206 indicates the number and quality of attributes that are necessary to describe a product contain data in fields in the input feed.

The final field score 204 is derived from individual field coverage scores 207. The mapped product score 205 is derived from the feedback provided by the comparison shopping engine and reflects how many products were successfully mapped to a comparison grid. The attribute extraction score 206 is derived from individual attribute scores 208. A manner of deriving individual scores is presented in the following paragraphs.

### Determining Fine-Granularity Feed Quality Scores

According to one embodiment, feed scoring system 100 generates fine-granularity quality scores for a data feed based on information contained in the summary data file 106 for the data feed. Feed scoring system 100 also generates coarser-granularity quality scores for the data feed based on the fine-granularity quality scores. The data feed for which feed scoring system 100 is currently generating quality scores is referred to herein as the “input feed”.

In one embodiment, the fine-granularity feed quality scores generated by feed scoring system 100 for the input data feed include “individual field” scores, and “individual attribute” scores.

### Individual Field Scores and Final Field Scores

“Field coverage” relates to whether the input feed has data in a certain field. If a high percentage of the products represented in the input feed have data for a field, then the field coverage for the field is relatively high. On the other hand, if a low percentage of products represented in the input feed have data from the field, then the field coverage for the field is low.

In one embodiment, an individual field score 207 is generated for each field across all products in a single category. For example, a first set of individual field coverage scores may be generated for fields such as price, size, and color based on products that fall into the category “apparel”. A second set of individual field coverage scores may be generated for fields such as price, size, and author based on products that fall into the category “books”. Therefore it is possible to have individual field coverage scores differ across categories for the same field. For example, the individual field coverage score for the field “price” might differ between categories “apparel” and “books”.

According to one embodiment, individual field coverage scores are calculated as a percentage. For a given field, two individual field scores are obtained. The first is based on data for an individual merchant (the merchant associated with the input feed). The second is based on data aggregated across all merchants appearing in the category. The individual field scores derived from data aggregated across all merchants appearing in the category is not used for computation of scores for the individual merchant. Rather, the individual field scores derived across all merchants are merely used for comparison. In one embodiment, individual field scores 207 are derived using formula (1):

No. of populated products/No. of total products=Individual Field Score % (1)

In formula (1), a number of populated products, is a count of products in the input feed, within a product category, which contain a value in a field for which the individual field score is being computed. The number of total products in formula (1) is the count of all products appearing in that same category in the input data feed. For example, if an input feed has only two products in the “book” category, and only one of the two “book” products specifies a price, then the individual field score for “price” for the “book” category would be 50%.

Individual field scores provide insight to feed submitters regarding quality of data submitted in individual fields and how that data compares to other merchants. For an individual merchant, the final field score 204 is derived using the formula (2):

Individual field score %*wt1+Individual field score %*wt2+Individual field score %*wt3 . . . =Final field score (2)

Final field score is derived by assigning weights (wt1, wt2, wt3 etc.) to individual fields, multiplying the individual field scores with the respective assigned weights and adding the multiplication results. Formula 2 is shown for deriving the final field score from 3 individual field scores, however the number of individual field scores may differ and the individual field scores can be accounted for by adding extra “individual field score %*wt” terms. For example an input feed contains a category “shoes”, inside the category “shoes” there are three fields “price”, “size”, and “color”. The three fields have individual field scores 100%, 100%, and 50%. The three fields have individual weights 0.5, 0.25, and 0.25 respectively. Using formula 2, the final field score for the example would be 0.5*100%+0.25*100%+0.25*50%=87.5%.

### Mapped Product Scores

The mapped product score 205 provides information on how many products were successfully mapped to a product comparison grid or a buyers guide. The feed scoring system computes a mapped product score for every category in the input feed. The following statistics are provided for each merchant: number of mapped products, number of unmapped products, total number of products, and percentage of mapped products. The number of matched products indicates the count of products within a category in the input feed that were successfully mapped to a comparison grid page. The number of total products is a count of products within the category within the input feed. Percentage of mapped products is calculated by formula (3):

No. of mapped products/No. of total products=Mapped products score (3)

A mapped products score is also calculated across all merchants in a given category. For example if two merchants submitted input feeds to the feed scoring system, statistics in the input feeds are combined. The number of mapped and unmapped products for all merchants would be computed by adding the number of mapped products and adding the number of unmapped products from both input feeds. The percentage of mapped products for all merchants is also derived using formula (3).

### Individual Attribute Scores and Attribute Extraction Scores

Attribute extraction score 206 indicates a number of quality attributes that were extracted for a given product from the name and description fields. Product attributes are fields that a shopping site determines to be necessary in order to adequately describe a product. Attributes are things like the color red in a “red dress” or male and size 9 in “male shoes size 9”. Products attributes are a subset of all the possible fields a product may have. Attributes aid in providing selection criteria when the product data is placed on a shopping site. Quality of an attribute is determined by checking if an attribute matches with one of the attributes that already exist in the product catalog or an attribute value dictionary. Individual attribute values may also have associated synonyms. Attribute extraction score is also indicative of the quality of the name and description of the products contained in the data feed.

A set of scores are produced to represent product attribute extraction score 206 of a selected merchant. Individual attribute scores 208 are extracted for all products within a category by first calculating a single attribute coverage score:

Single attribute coverage score=Count of quality attributes extracted from name and description fields/sum of applicable products within a category

Single attribute coverage scores are derived for individual attributes. An applicable product within a product category is one which contains the same attributes as specified necessary by the shopping site. For example in a product category “adult apparel”, products such as pants possessing attributes waist size and inseam, will belong to one group of “applicable products within a category”. While products such as dress shirts, belonging to the same category “adult apparel”, have a different set of attributes such as neck size and sleeve length, will belong to a different group of “applicable products”. Individual attribute score 208, is derived from the single attribute score by applying certain weighting criteria using formula (4):

Individual attribute score=(single attribute coverage score*product count weight)*weight. (4)

Weight is an adjustable parameter that is used to reflect the relative importance of an attribute in particular category. Weight of an attribute may differ from one category to another.

Product count weight describes a proportion of products requiring a certain set of attributes in a category. A single attribute coverage score with more applicable products is weighted more heavily than a single attribute coverage score with fewer applicable total products. The product count weight is derived using formula (5).

Product count weight=sum of applicable products for a particular attribute within a category/sum all products within a category. (5)

The attribute extraction score 206 is derived as follows:

attribute extraction score=sum of individual attribute scores/number of total applicable attributes within a category.

The number of total applicable attributes within a category is the count of all the fields that make up attributes within a category.

Consider an example input feed containing a category “adult apparel”. Within “adult apparel” category, there are a total of 5 products offered for sale, 2 shirts and 3 pants. For pants there are 3 attributes, inseam, waist size, and color, for shirts there are also 3 attributes neck size, sleeve length, and color. Single attribute coverage scores are calculated for each attribute. In this example attributes waist size and inseam were successfully extracted from the description field and title field of every pair of pants in the input feed. Therefore the single attribute coverage scores were; for inseam 3/3=1, and for waist size 3/3=1. For the shirts in the input feed, neck size attribute was obtained from the description field for both shirts offered, resulting in a single attribute coverage score of 2/2=1 for neck size attribute. The sleeve length attribute was only successfully obtained for 1 shirt resulting in a 1/2=0.5 single attribute score. The color attribute was extracted for 2 pants and 1 shirt, resulting in a single attribute score for color of 3/5=0.6.

Weights for product attributes are arbitrarily assigned by the feed scoring system operator. In this example we will use the same weights for all attributes i.e. 1/5. The product count weight is calculated for each attribute. Inseam and waist size” attributes will receive a product count weight of 3/5=0.6 because there are 3 products possessing the attribute inseam and waist size out of total of 5 products in the category “adult apparel”. Following similar computation, the sleeve length and neck size attributes will receive a product count weight of 2/5=0.4, while the color attribute will receive 5/5=1.0 because all products in the category “adult apparel” contain the value for the attribute color.

Individual attribute scores are then derived for every attribute. For example, neck size individual attribute score is calculated as 1/5 (weight)*2/5(product count weight)*1 (single attribute coverage score)=2/25. Sleeve length individual attribute score is calculated as 1/5(weight)*2/5 (product count weight)*1/2(single attribute coverage score)=1/25. Inseam individual attribute score is calculated as 1/5 (weight)*3/5(product count weight)*1 (single attribute coverage score)=3/25. Waist size individual attribute score is calculated as 1/5 (weight)*3/5(product count weight)*1 (single attribute coverage score)=3/25. Finally the color individual attribute score is calculated by 1/5 (weight)*1(product count weight)*1 (single attribute coverage score)=1/5.

The attribute extraction score 206 is calculated in the current example by taking the sum of individual attribute scores calculated in the previous paragraph and dividing by the total number of attributes (2/25+1/25+3/25+3/25+1/5)/5=14/125.

### Category Score

The category score 203 is derived from final field score 204, mapped product score 205, and attribute extraction score 206. The category score is derived for each category with at least one product. Category score 203 is calculated by:

Field score*0.5+Mapped Products Score*0.25+Attribute Extraction Score*0.25=Category score.

If there are multiple product categories, category scores 203 are calculated for each category. The weights assigned to Field score, Mapped Product Score, and Attribute Extraction Score need not be fixed to 0.5, 0.25, and 0.25 and can be adjusted by an administrator of the feed scoring system.

### Type Score

Type scores 202 are derived in part from category scores. Category scores are assigned weights proportional to the number of products within each category. Categories with fewer products will contribute less to the type score 202, than categories with a higher number of products. If the summary data file contains multiple product types, type scores are computed for each type.

Weights assigned to categories are derived by calculating:

No. of products in a category/No. of products in feed=category weight %.

Having computed the product category weights, the type score is computed by formula (6).

Category1 weight %*category1 score+Category2 weight %*category2 score+ . . . =Type Score. (6)

Because a product type may contain multiple categories each category having different number of products, the type score may be a sum of multiple category scores and category weights.

### Feed Score

The feed score 201 is indicative of quality of the entire feed. Feed score 201 is derived from product type scores.

(Type 1 Score+Type 2 Score+ . . . )/Number of types=feed score.

Feed scores 201 are calculated for every feed submitted by each merchant.

The scoring system generates score averages across multiple merchants. The following averages are generated: average feed score for all merchants, average score for each category for all merchants, average final field scores, average mapped product score, and average attribute extractions core.

### Presentation of Feed Quality Scores

The feed scoring system provides a user an insight into the amount and quality of data that a merchant is providing in a feed. In an embodiment of the invention, the feed scoring system contains a user interface which presents feed scores at various levels of detail. The feed scoring system user interface initially presents users with a high-level view of feed data, and averages computed across multiple merchants. The user interface allows users to expand individual scores, successively presenting a larger amount of data about the feed. Conversely, scores of higher level of detail can be collapsed in order to view scores of lower level of detail.

At the lowest level of detail, the scoring system presents a user with a selected merchant feed score 201 as well as the average feed score for all merchants. The user may examine individual type scores 202 that make up the feed score 201. At the next level of detail, type scores 202 as well as type score averages across multiple merchants are presented. The user may examine data used to derive individual type scores 202 by navigating to category level scores 203. At category level of detail category scores 203 and category score averages across multiple merchants are presented. Scores used to derive category scores 203 may also be individually examined, i.e. the final field score 204, mapped product score 205, and attribute extraction score 206. The final field score 204 may be further examined by looking at individual field scores 207. The attribute extraction score 206 may be examined by looking at individual attribute scores 208.

The scoring apparatus will also allow users to view historical feed data, for use in historical comparisons. Scores of a particular data feed are saved so that it is possible to compare various submissions. Similarly, the scoring apparatus will show the feed score compared to other merchant's scores, the average, top, low, and median scores of all feeds, as well as the scores of merchants with similar products In other embodiments the scoring system can be customized to score data feeds for other types of products such as trips etc. In an alternate embodiment a data feed can be generated by a web crawler, instead of being provided by a merchant. In an embodiment where the data feed is provided by a web crawler, the feed quality scores will reflect the quality of the web sites crawled as well as the performance of the web crawler. The scoring system can be customized by changing data input format and scoring weights.

### Hardware Overview

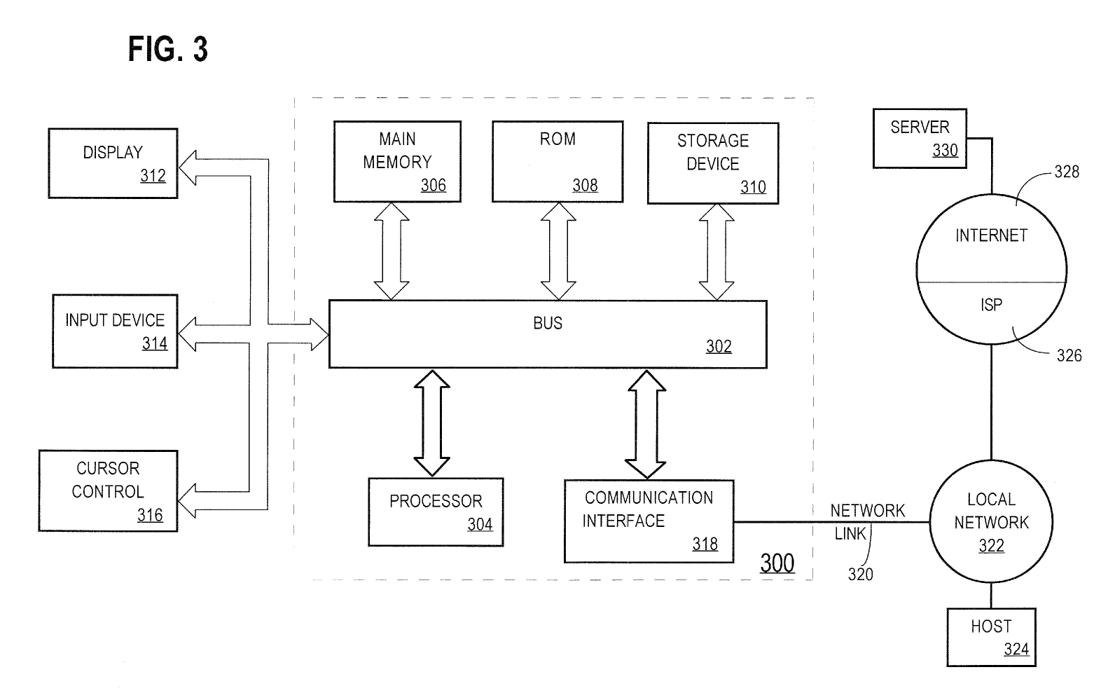

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer implemented method comprising:
generating a set of feed quality scores for a data feed;
wherein each feed quality score in the set of feed quality scores is a measure of quality of a distinct characteristic of a data feed;
wherein the data feed is electronic information about items, wherein the data feed includes, for each item, a value for at least one field; and
outputting the set of feed quality scores.

2. The method of claim 1 wherein the set of feed quality scores includes a mapped product score;
wherein the mapped product score is a percentage of items in the data feed that were mapped to a comparison grid.

3. The method of claim 1 wherein the set of feed quality scores includes an individual attribute score;
wherein the individual attribute score indicates the number of attributes that were successfully extracted from a name field and a description field in the data feed.

4. The method of claim 1 wherein the set of feed quality scores includes an individual field score;
wherein the individual field score is a percentage of items in the data feed that contained a value for a particular field in the data feed.

5. The method of claim 1 wherein:
the set of feed quality scores includes a score hierarchy, the score hierarchy includes:
one or more finer granularity scores; and
one or more coarser granularity scores derived from said finer granularity scores.

6. The method of claim 1 wherein the data feed is a file.

7. The method of claim 1 wherein a set of summary data is generated based in part on each item represented in said data feed, and said set of feed quality scores is generated based on the set of summary data.

8. The method of claim 7 wherein said set of summary data contains field coverage data:
wherein the field coverage data indicates presence of a value in each field for each item in the data feed.

9. The method of claim 7 wherein said set of summary data contains product categorization data:
wherein the product categorization data indicates the category each item in the data feed belongs to.

10. The method of claim 7 wherein said set of summary data contains comparison grid matching data:
wherein the comparison grid matching data indicates which items in the data feed were mapped in a comparison grid.

11. The method of claim 7 where generating a set of feed quality scores comprises the steps of:
placing items contained in said summary data into categories;
computing a set of fine granularity quality scores based on said items in said categories; and
computing a set of coarse granularity feed quality scores based in part on first set of fine granularity feed quality scores.

12. The method of claim 2 wherein the set of feed quality scores includes a category score that indicates the quality of the data feed with respect to the items which belong to one category:
wherein the category score is based, in part on, the mapped product score.

13. The method of claim 1 wherein said set of feed quality scores includes a type score that indicates the quality of the data feed with respect to all items belonging to one type of items:
wherein the type score is based, in part on, one or more category scores.

14. The method of claim 4 wherein said set of feed quality scores contains a final field score that indicates the quality of all fields for all items belonging to one category in the data feed:
wherein the final field score is based, in part on, on the individual field score.

15. The method of claim 3 wherein said set of feed quality scores contains an attribute extraction score that indicates the number of attributes that were extracted from a name field and a description field in the data feed:
wherein the attribute extraction score is based, in part on, the individual attribute score.

16. The method of claim 1 wherein the data feed is provided by a merchant to a comparison shopping engine.

17. The method of claim 1 wherein multiple data feeds are provided by multiple merchants.

18. The method of claim 1 wherein Calculating quality scores based on quality scores for multiple merchants.

19. A computer-readable medium carrying one or more sequences of instructions which, when executed by one or more processors, causes the one or more processors to perform the method recited in claim 1.

20. A computer-readable medium carrying one or more sequences of instructions which, when executed by one or more processors, causes the one or more processors to perform the method recited in claim 2.

21. A computer-readable medium carrying one or more sequences of instructions which, when executed by one or more processors, causes the one or more processors to perform the method recited in claim 3.

22. A computer-readable medium carrying one or more sequences of instructions which, when executed by one or more processors, causes the one or more processors to perform the method recited in claim 4.

23. A computer-readable medium carrying one or more sequences of instructions which, when executed by one or more processors, causes the one or more processors to perform the method recited in claim 5.

24. A computer-readable medium carrying one or more sequences of instructions which, when executed by one or more processors, causes the one or more processors to perform the method recited in claim 6.

25. A computer-readable medium carrying one or more sequences of instructions which, when executed by one or more processors, causes the one or more processors to perform the method recited in claim 7.

26. A computer-readable medium carrying one or more sequences of instructions which, when executed by one or more processors, causes the one or more processors to perform the method recited in claim 8.

27. A computer-readable medium carrying one or more sequences of instructions which, when executed by one or more processors, causes the one or more processors to perform the method recited in claim 9.

28. A computer-readable medium carrying one or more sequences of instructions which, when executed by one or more processors, causes the one or more processors to perform the method recited in claim 10.

29. A computer-readable medium carrying one or more sequences of instructions which, when executed by one or more processors, causes the one or more processors to perform the method recited in claim 11.

30. A computer-readable medium carrying one or more sequences of instructions which, when executed by one or more processors, causes the one or more processors to perform the method recited in claim 12.

31. A computer-readable medium carrying one or more sequences of instructions which, when executed by one or more processors, causes the one or more processors to perform the method recited in claim 13.

32. A computer-readable medium carrying one or more sequences of instructions which, when executed by one or more processors, causes the one or more processors to perform the method recited in claim 14.

33. A computer-readable medium carrying one or more sequences of instructions which, when executed by one or more processors, causes the one or more processors to perform the method recited in claim 15.

34. A computer-readable medium carrying one or more sequences of instructions which, when executed by one or more processors, causes the one or more processors to perform the method recited in claim 16.

35. A computer-readable medium carrying one or more sequences of instructions which, when executed by one or more processors, causes the one or more processors to perform the method recited in claim 17.

36. A computer-readable medium carrying one or more sequences of instructions which, when executed by one or more processors, causes the one or more processors to perform the method recited in claim 18.
